(19) United States
(12) Patent Application Publication
(10) Pub. No.: US 2023/0346151 A1
(43) Pub. Date: Nov. 2, 2023

(54) AUTOMATED FOOD STORAGE AND MEAL PREPARATION SYSTEM

(71) Applicant: Your Food Robotics, Inc., Claymont, DE (US)

(72) Inventors: Pavel Shvets, Claymont, DE (US); Sergey Yanovich, Claymont, DE (US)

(21) Appl. No.: 18/019,572

(22) PCT Filed: Aug. 4, 2021
(86) PCT No.: PCT/US2021/044514

§ 371 Date: Feb. 3, 2023

Related U.S. Application Data
(60) Provisional application No. 63/061,792, filed on Aug. 5, 2020.

(51) Int. Cl. A47J 27/14; A47J 44/00; A47J 27/00; G07F 11/16; G07F 17/00

(52) U.S. Cl. CPC A47J 27/14; A47J 44/00; A47J 27/004; G07F 11/163; G07F 17/0078

(57) ABSTRACT

An automated meal preparation system can include food storage matrix(es) with chute(s), food storage cartridge(s), mechanical cartridge dispenser(s), basket(s), manipulator(s), actuator(s), conveyer(s), buffer queue(s), gripper(s), catapult arm(s), cooking receptacle(s), and processor(s). A manipulator can move a basket to a chute where an actuator actuates a mechanical cartridge dispenser to pass a cartridge into the basket. The manipulator can move the cartridge to the conveyer, which moves the cartridge to a buffer queue at a conveyer gate. A gripper at the buffer queue can accept the cartridge and move it to an unpacking position where a catapult arm operates with the gripper to separate a cartridge lid from a cartridge container. The catapult arm can rotate the cartridge to empty its food into a cooking receptacle that spins while cooking the food. Processor(s) can control the motions of the manipulator, conveyer, gripper, catapult arm, and cooking receptacle.

### CROSS-REFERENCE TO RELATED APPLICATIONS

This application claims priority to U.S. Provisional Application No. 63/061,792, filed Aug. 5, 2020, the contents of which is incorporated by reference in its entirety.

### TECHNICAL FIELD

The present disclosure relates generally to food handling, and more particularly to the storage of food and preparation of meals and other food products.

### BACKGROUND

Meal preparation can be a time and labor-intensive process. Many restaurants, cafeterias, and other food service providers employ chefs, cooks, and other food preparation personnel both on full time and part time bases. Although there are some ways to prepare and store meals and dishes in advance, people usually prefer food that is freshly prepared just prior to eating. People also prefer a wide variety of meals and dishes, such that restaurants having a greater number of meal choices and even the ability to prepare custom orders can be more popular.

Unfortunately, labor costs can often be significant with respect to the manual preparation of fresh meals and other food products. Restaurants, cafeterias, and other food service providers often employ multiple chefs, cooks, and other food preparers, with the attendant costs for having such workers. In addition, the use of multiple food preparation personnel can often result in inconsistencies in the preparation of identical meals or food orders. Such inconsistencies can be undesirable in the restaurant industry, which may lead to the loss of choosy consumers who have many other options. The competitive and low margin nature of the restaurant industry results in meal providers looking for any possible edge.

Although traditional ways of preparing meals and other food products have worked well in the past, improvements are always helpful. In particular, what is desired are meal preparation systems and methods that are cheaper and more consistent while still maintaining high quality.

### SUMMARY

It is an advantage of the present disclosure to provide an automated food storage and meal preparation system. The disclosed features, apparatuses, systems, and methods provide improved food storage and meal preparation solutions that result in the cheaper and more consistent preparation of meals while still maintaining high quality in the finished food products. These advantages can be accomplished by providing an automated meal preparation system that reduces the amount of manual labor required to prepare fresh meals. In particular, the provided meal preparation system and methods can utilize various robotic elements coordinated into an overall process that is controlled by one or more processors.

In various embodiments of the present disclosure, an automated meal preparation system can include at least a food storage matrix, a mechanical cartridge dispenser, and a basket that receives and transports food storage cartridges. The food storage matrix can include a plurality of chutes arranged in rows, columns, or both. One or more of the plurality of chutes can be configured to hold a plurality of reusable or disposable food storage cartridges, and at least some of the plurality of chutes can include a loading end and a dispensing end. A mechanical cartridge dispenser can be located at the dispensing end of one or more of the plurality of chutes. Each mechanical cartridge dispenser can have first and second blocking elements and an actuation stem. Both of the first and second blocking elements can have a first position that blocks the passage of food storage cartridges and a second position that allows the passage of food storage cartridges. The basket can receive a food storage cartridge when the basket is positioned at the dispensing end of one of the plurality of chutes, and the basket can be configured to be manipulated by a robotic manipulator to transport food storage cartridges from the food storage matrix to a downstream component of the automated meal preparation system.

In various detailed embodiments, at least some of the plurality of chutes can have the loading end elevated higher than the dispensing end so that gravity forces food storage cartridges down these chutes from the receiving end toward the dispensing end. The food storage matrix can also include a refrigeration component that controls the temperature of the food storage cartridges. The downstream component can be a conveyer having a receiving end and one or more gates. Each mechanical cartridge dispenser can be spring loaded to a default position where the first blocking element is in the first position and the second blocking element is in the second position, with the first blocking element blocking a food storage cartridge at the dispensing end of the chute. When the actuation stem is actuated, the first blocking element can move from the first position to the second position, the second blocking element can move from the second position to the first position, and the food storage cartridge at the dispensing end of the chute can pass to the basket while the next food storage cartridge in the chute is blocked. A processor can control the tracking of food stored in the food storage matrix and the location and contents of every food storage cartridge located in the food storage matrix. In various arrangements, the system can include the plurality of food storage cartridges. Each food storage cartridge can include container, a lid, and a unique identifier that is machine readable by the automated meal preparation system. The unique identifier can be contained in a bar code, QR code, RFID component, or other machine-readable identifier.

In further embodiments of the present disclosure, an automated meal preparation system can include the foregoing food storage matrix, mechanical cartridge dispenser, and basket, and can also include a manipulator, an actuator, a conveyer, one or more buffer queues, one or more grippers, one or more catapult arms, one or more cooking receptacles, and at least one processor configured to control various system components. The manipulator can be coupled to the basket and can move the basket to the dispensing end of one of the plurality of chutes to receive a food storage cartridge located at the dispensing end of the chute. The actuator can be located at the basket and can actuate the actuation stem of the mechanical cartridge dispenser of a chute when the basket is located at the dispensing end of the chute such that a food storage cartridge passes from the chute into the basket. The conveyer can have a receiving end and one or more gates, and the manipulator can move the basket from the dispensing end of a chute to the receiving end of the conveyer to transport a food storage cartridge from the chute onto the receiving end of the conveyer. A buffer queue can extend from each of the one or more gates, and each buffer queue can have a receiving end at the gate that is elevated above a delivery end such that a food storage cartridge travels from the receiving end to the delivery end. A gripper can be located at the delivery end of each buffer queues, and the gripper can hold a food storage cartridge that has traveled along the buffer queue and move the food storage cartridge from a receiving position to an unpacking position. A catapult arm having a holding component can holds the container of a food storage cartridge at the unpacking position and operate with the gripper to separate the food storage cartridge lid from the food storage cartridge container. The gripper can then move the food storage cartridge lid away from the food storage cartridge container, and the catapult arm can then rotate to empty food from the food storage cartridge container after separation. A cooking receptacle can receive the food from the food storage cartridge container when the catapult arm empties the food. The cooking receptacle can have an upper opening that receives the food, a bottom, one or more sidewalls, at least one protrusion extending inward from the one or more sidewalls, a heating element positioned behind at least one of the one or more sidewalls, a spinner, and a rotator. The spinner can spin the cooking receptacle while the at least one protrusion mixes the food while the heating element cooks the food. The rotator can then rotate the cooking receptacle to empty the food from the cooking receptacle when the food is finished cooking. The processor(s) can control the motions of the manipulator, conveyer, gripper, catapult arm, and cooking receptacle. In some arrangements, food from multiple separate food storage cartridges can be emptied into the cooking receptacle and cooked together before the food is emptied from the cooking receptacle. Each gate, buffer queue, gripper, and catapult arm combination can represent a module, and an overall system can have multiple modules, such as four to ten modules. These can include “salad,” “soup,” and “hot bowl” modules, among other possible modules.

In further embodiments, a cooking receptacle for an automated meal preparation system can include an upper opening configured to receive food, a bottom, one or more sidewalls, a heating element positioned behind at least one of the one or more sidewalls, a spinner that spins the cooking receptacle while the heating element cooks the food, at least one protrusion extending inward from the one or more sidewalls that mixes the food when the spinner spins the cooking receptacle, and a rotator that rotates the cooking receptacle to empty the food from the cooking receptacle when the food is finished cooking. The one or more sidewalls can include an external circular sidewall and an internal circular sidewall having a non-stick coating situated within the external circular sidewall. The heating element can include an electrical heating coil coaxially placed between the external and internal circular sidewalls.

In still further embodiments, various methods of automatically preparing a meal can include a variety of steps, some or all of which may be automated. All steps may be performed in the various methods, as well as subsets of any combination of steps. Process steps can include storing food, accepting a meal order, moving a basket to a chute, actuating a mechanical cartridge dispenser at the chute, receiving a food storage cartridge into the basket from the chute, transporting the food storage cartridge to a conveyer, passing the food storage cartridge along the conveyer, guiding the food storage cartridge along a buffer queue, gripping the food storage cartridge at the end of the buffer queue, shifting the food storage cartridge to an unpacking position, holding the food storage cartridge at the unpacking position, separating the lid from the container of the food storage cartridge, removing the lid away from the container, flipping over the container to remove its food contents, receiving the food contents into a cooking receptacle, cooking the food contents while spinning the cooking receptacle, and rotating the cooking receptacle to empty the cooked food contents.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for automated food storage and meal and food product preparation. These drawings in no way limit any changes in form and detail that may be made to the disclosure by one skilled in the art without departing from the spirit and scope of the disclosure.

FIG. 1A illustrates in front perspective view the front end of an exemplary automated food storage and meal preparation system according to one embodiment of the present disclosure.

FIG. 1B illustrates in side perspective view front and back ends of the exemplary automated food storage and meal preparation system of FIG. 1A according to one embodiment of the present disclosure.

FIG. 2 illustrates a schematic diagram of an exemplary automated food storage and meal preparation system according to one embodiment of the present disclosure.

FIG. 3 illustrates in front perspective view an exemplary food storage cartridge for an automated food storage and meal preparation system according to one embodiment of the present disclosure.

FIG. 4A illustrates in front perspective view an exemplary food storage matrix, manipulator, and basket for an automated food storage and meal preparation system according to one embodiment of the present disclosure.

FIG. 4B illustrates in front perspective view an exemplary conveyer with gates, grippers, and catapult arms for an automated food storage and meal preparation system according to one embodiment of the present disclosure.

FIG. 5A illustrates in rear perspective view an exemplary food storage matrix for an automated food storage and meal preparation system according to one embodiment of the present disclosure.

FIG. 5B illustrates in front perspective view the exemplary food storage matrix of FIG. 5A with a food storage cartridge in a chute thereof according to one embodiment of the present disclosure.

FIG. 6A illustrates in front perspective view an exemplary mechanical cartridge dispenser at the dispensing end of a matrix chute for an automated food storage and meal preparation system according to one embodiment of the present disclosure.

FIG. 6B illustrates in side elevation view the exemplary mechanical cartridge dispenser of FIG. 6A with two food storage cartridges loaded at the dispensing end of the matrix chute according to one embodiment of the present disclosure.

FIG. 7A illustrates in front perspective view the exemplary food storage cartridge of 6A being manually actuated according to one embodiment of the present disclosure.

FIG. 7B illustrates in side elevation view the exemplary mechanical cartridge dispenser of FIG. 6B after actuation with one food storage cartridge dispensed and the other food storage cartridge remaining in the matrix chute according to one embodiment of the present disclosure.

FIG. 8A illustrates in front perspective view an exemplary empty basket positioned at the dispensing end of a food storage matrix chute according to one embodiment of the present disclosure.

FIG. 8B illustrates in bottom perspective view an exemplary actuator at the bottom of the basket of FIG. 8A according to one embodiment of the present disclosure.

FIG. 8C illustrates in top perspective view an exemplary basket and actuator positioned at food storage matrix chute prior to actuation according to one embodiment of the present disclosure.

FIG. 8D illustrates in top perspective view the exemplary basket and actuator of FIG. 8C after actuation according to one embodiment of the present disclosure.

FIG. 9A illustrates in front perspective view the exemplary configuration of FIG. 8A with a food storage cartridge from the food storage matrix dispensed into the basket according to one embodiment of the present disclosure.

FIG. 9B illustrates in front perspective view the exemplary basket of FIG. 9A transporting the food storage cartridge therein according to one embodiment of the present disclosure.

FIG. 9C illustrates in side perspective view the exemplary basket with food storage cartridge of FIG. 9B at the dispensing end of a conveyer according to one embodiment of the present disclosure.

FIG. 9D illustrates in side perspective view the exemplary basket of FIG. 9C rotated downward to dispense the food storage cartridge onto a conveyer according to one embodiment of the present disclosure.

FIG. 9E illustrates in front perspective view the exemplary rotated basket with food storage cartridge of FIG. 9D and the receiving end of a conveyer according to one embodiment of the present disclosure.

FIG. 9F illustrates in front perspective view the exemplary rotated basket of FIG. 9E with the food storage cartridge passing onto the conveyer according to one embodiment of the present disclosure.

FIG. 10A illustrates in front perspective view the exemplary rotated basket of FIG. 9F and the food storage cartridge traveling on the conveyer according to one embodiment of the present disclosure.

FIG. 10B illustrates in side perspective view an exemplary gate and diverting arm along the conveyer of FIG. 10A according to one embodiment of the present disclosure.

FIG. 11A illustrates in front perspective view an exemplary conveyer with four gates, grippers, and catapult arms, with the food storage cartridge being diverted through the gate of FIG. 10B according to one embodiment of the present disclosure.

FIG. 11B illustrates in top perspective view an exemplary buffer queue at the gate of FIG. 10B according to one embodiment of the present disclosure.

FIG. 12A illustrates in front perspective view the conveyer of FIG. 11A with the food storage cartridge being gripped by an exemplary gripper at the end of the buffer queue of FIG. 11B according to one embodiment of the present disclosure.

FIG. 12B illustrates in front perspective view the food storage cartridge moved to an unpacking position by the gripper of FIG. 12A according to one embodiment of the present disclosure.

FIG. 13A illustrates in side perspective view an exemplary catapult arm prior to contacting the food storage cartridge held by the gripper according to one embodiment of the present disclosure.

FIG. 13B illustrates in front perspective view the catapult arm and gripper of FIG. 13A holding the food storage cartridge according to one embodiment of the present disclosure.

FIG. 13C illustrates in front perspective view the gripper moving the separated food storage cartridge lid away from the food storage cartridge container held by the catapult arm according to one embodiment of the present disclosure.

FIG. 13D illustrates in front perspective view the food storage cartridge container being flipped over by the catapult arm according to one embodiment of the present disclosure.

FIG. 14A illustrates in front perspective view an exemplary cooking receptacle for an automated food storage and meal preparation system according to one embodiment of the present disclosure.

FIG. 14B illustrates in front perspective view the cooking receptacle of FIG. 14A after receiving food and tilting according to one embodiment of the present disclosure.

FIG. 14C illustrates in front perspective view the cooking receptacle of FIG. 14B spinning and cooking the received food according to one embodiment of the present disclosure.

FIG. 14D illustrates in front perspective view the cooking receptacle of FIG. 14C fully rotated upside down for cleaning after cooking and dispensing the received food according to one embodiment of the present disclosure.

FIGS. 15A-15D illustrate example flow diagrams for operating a food preparation system to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, and methods for automating the storage and preparation of a variety of meals and food products. The disclosed embodiments provide improved food storage and meal preparation solutions that result in the cheaper and more consistent preparation of meals while still maintaining high quality in the finished food products. The provided automated meal preparation system uses various processor controlled robotic elements to reduce the amount of manual labor required and inconsistencies inherent to these activities. This system can reduce costs by 50 to 70 percent and can cook twice as fast as typical commercial kitchens for restaurants and other food preparation facilities. Peak productivity can reach up to 600 dishes per hour, which is the equivalent of a dozen or more cooks working together.

Other advantages realized by the disclosed system and methods include increased storage times and food quality due to individual portion preservation modules or cartridges, increased dish varieties due to the flexibility in combining ingredients from different stored individual food storage cartridges, decreased food waste due to detailed digital food supply chain management, decreased cleaning costs due to minimized food contact surfaces and automated cleaning functions, and adoptive production facilities due to the flexibility of having many different stored food portions.

Although various embodiments disclosed herein discuss a food storage and meal preparation system suitable for the creation of fresh meals and food products in restaurants, cafeterias, and the like, it will be readily appreciated that the disclosed features, apparatuses, systems, and methods can similarly be used for any relevant food handling or meal preparation entity. For example, food processing plants and other meal preparation entities may use the disclosed systems and methods to prepare meals and food products prior to freezing, shipping, or otherwise distributed the processed foods. Alternatively, or in addition, the disclosed systems and methods may be used in homes or other relatively small private or public settings. Other applications, arrangements, and extrapolations beyond the illustrated embodiments are also contemplated.

In various detailed examples, which are merely illustrative and non-limiting in nature, an overall meal preparation system can include components such as a food storage matrix having chutes, food storage cartridges for holding food in the matrix chutes, mechanical cartridge dispensers located at dispensing ends of the chutes, a robotic manipulator configured to select and move the food storage cartridges from the chutes, actuators configured to dispense the food storage cartridges from the chutes, grippers and catapult arms configured to separate the cartridge lids from the cartridge containers and empty food contents therefrom into cooking receptacles, and one or more processors configured to control some or all of these components robotically. In further detailed embodiments, unique cooking receptacles can receive food contents from one or more food storage cartridges, mix the food contents while cooking them, and dispense the prepared meals or food contents for serving or further processing. In some embodiments, the cooking receptacles can be part of the overall system. In various arrangements, the disclosed systems can include a combination of food preparation modules in the form of salad preparation module(s), soup preparation module(s), and hot bowl preparation module(s). Some systems may not have one or more of these three general types of food preparation modules, and other types of food preparation modules and variations thereof may be included in some arrangements, as will be readily appreciated.

### Overall System

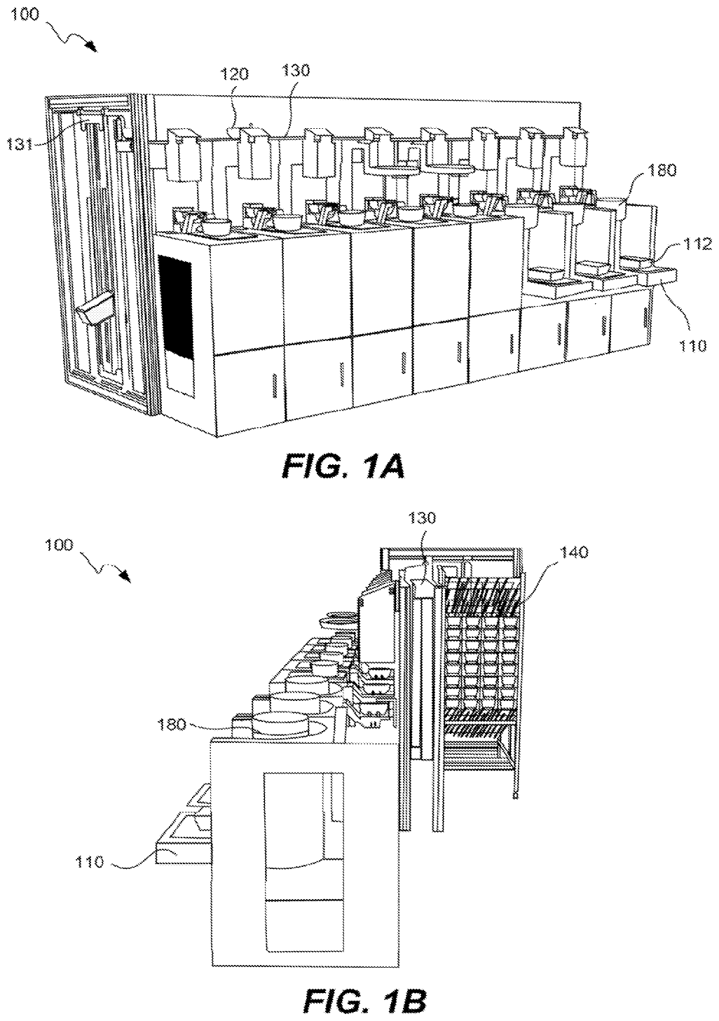

Referring first to FIG. 1A, a front end of an exemplary automated food storage and meal preparation system is illustrated in front perspective view. The main purpose of the overall automated food storage and meal preparation system 100 can be to supply the proper ingredients at the proper times for preparation of a selected dish or meal. System 100 can include a front counter 110 with multiple prepared meal serving stations and multiple cooked food receiving regions 112. One or more food storage cartridges 120 can travel automatically down a conveyer 130 or other moving component after being received onto the conveyer through opening 131. Food contents from each food storage cartridge 120 can be emptied automatically into a food preparation receptacle at a food preparation module, such as a cooking receptacle 180, where the food can then be automatically mixed, cooked, and/or otherwise prepared before being deposited to a food receiving region 112. Food from several food storage cartridges 120 can be emptied into a cooking receptacle 180 and mixed during the food preparation process. In some situations, all food can be mixed before cooking, while other cases can involve the cooking of some ingredients before further ingredients are added and cooked together with the first ingredients. Some arrangements can simply involve the mixing or combining of food ingredients without cooking. For example, the food preparation receptacle can be a salad mixer where the food preparation module is a salad module, or a soup preparation unit where the food preparation module is a soup module.

FIG. 1B illustrates in side perspective view front and back ends of the exemplary automated food storage and meal preparation system of FIG. 1A. In addition to the front end components of a front counter 110, conveyer 130, and food preparation receptacles, such as cooking receptacles 180, the back end of system 100 can include a food storage matrix 140 where individual portions of food are stored in multiple food storage cartridges 120 in preparation for later transport and cooking. Although shown for purposes of illustration and discussion, it will be appreciated that front counter 110 or other serving regions are not necessary for all system embodiments. In addition, devices other than or in addition to a conveyer 130 can be used to transport food storage cartridges automatically through the system 100. For example, a vacuum tube arrangement can be used to move food storage cartridges automatically through the system.

In various embodiments, three different types of food preparation modules can be included with an overall food storage and meal preparation system 100. These can include “salad,” “soup,” and “hot bowl” modules, among other possible modules. Although system 100 of FIGS. 1A-1B depicts three soup modules to the left, two salad modules in the middle, and three hot bowl modules to the right, any combination of food preparation modules may be used in a given system. For example, anywhere from four to ten food preparation modules can be used with a single system, and the types of modules used can be mixed and matched as may be desired. In some arrangements, a salad module may be able to prepare a salad dish in about one minute, a soup module may be able to prepare a soup dish in about two minutes, and a hot bowl module may be able to prepare a cooked dish in about three minutes. Different modules in the same system may prepare different dishes simultaneously for increased efficiency.

A salad module can be relatively simple compared to a soup module or hot bowl module since no cooking procedure is typically needed for salad preparation. Salad preparation at a salad module can simply involve providing ingredients from one or more food storage cartridges into a salad bowl. For example, ingredients can fall directly from food storage cartridges into the salad bowl. Although a mixing element may be provided for such a salad bowl, it is specifically contemplated that such mixing may not be necessary for some or all salads prepared at a salad module. Where mixing is not desired, a salad module can merely be a stand with a salad bowl keeper.

A soup module can be similar to the salad module, except that the soup module can also include a boiler or kettle to help prepare a soup dish. For example, a soup module can be used to prepare soup with ingredients that are stored cold (e.g., at about 40° F.), which are then added to liquid bouillon that has been heated (e.g., stored at about 150° F.) in the boiler or kettle. A spout or other outlet from the boiler or kettle can provide heated bouillon into a soup bowl. The chilled ingredients can be added to the soup bowl at the soup module, after which the bouillon is added and heated to about 200° F. during a cooking process, after which the prepared soup can be served.

A hot bowl module can be used to prepare hot meals or dishes using a cooking receptacle that can cook and mix the ingredients, further details of which are provided below. While hot bowl modules can be relatively more complex than salad modules or soup modules, it is specifically contemplated that an overall system is able to make use of all three types of modules seamlessly to prepare a wide variety of different food dishes. Furthermore, some arrangement of the overall system can be modular in nature, such that different food preparation modules can be reordered and even interchanged as may be needed. For example, an overall system having the eight food preparation modules as shown in FIGS. 1A-1B may become inefficient in a specific environment where demand for salads grows more prevalent for the local consumers of that overall system. Accordingly, one or more of the soup modules or hot bowl modules may be converted into or may be replaced with additional salad module(s) in order to meet the specific relative demands that are being made on that given overall system.

In various embodiments, the disclosed automated meal preparation systems can be containable within a relatively compact indoor environment. This distinguishes the disclosed systems from large industrial food processing systems that are not appropriate for smaller consumer environments such as restaurants, cafeterias, and the like. An indoor environment suitable for containing the disclosed automated meal preparation systems can have a common electrical capacity for restaurants or cafeterias, such as, for example, at least 4 kilowatts. Furthermore, such a suitable indoor environment can have an overall area configured to contain the disclosed system of less than about 32 square meters. This overall area can include a region of less than about 3 square meters for loading food storage cartridges into a food storage matrix and 8 square meters for serving prepared meals, as detailed below.

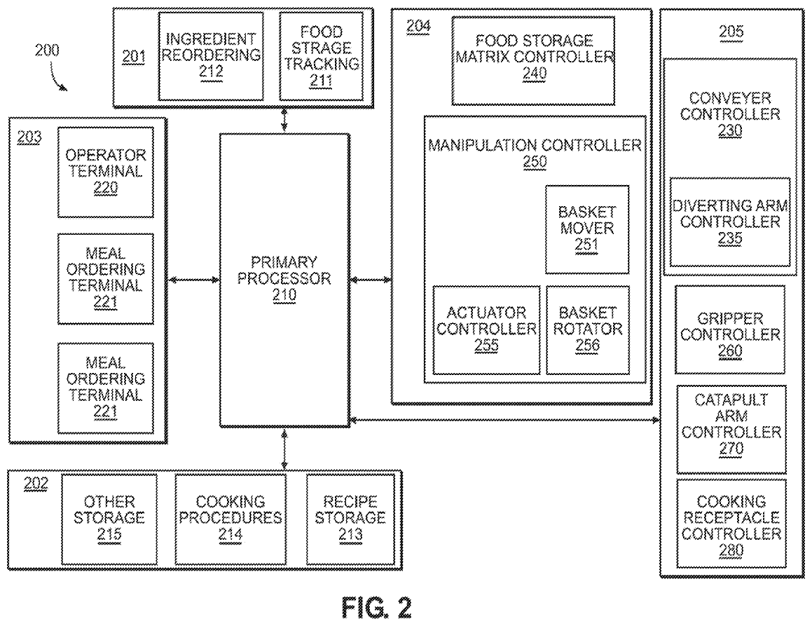

Various components of the provided automated food storage and meal preparation system can be robotically controlled using one or more processors. FIG. 2 provides a schematic diagram of an exemplary automated food storage and meal preparation system. Automated food storage and meal preparation system 200 can include a primary processor 210 configured to control and coordinate various components and modules in the system. In various embodiments, the primary processor 210 can be in direct or at least indirect communication with all system components and modules. Various system components can be grouped into subsystems or modules, such as an automated tracking control module 201, an automated storage module 202, a terminal control module 203, a system back end module 204, and a system front end module 205. In some embodiments, primary processor 210 can control all robotic activities. Alternatively, system 200 can have multiple processors distributed throughout the system, with primary processor 210 providing instructions to the distributed processors for a smooth system operation. For example, each module can have its own separate processor and each robotic component within module may also have its own separate processor to control operations of that robotic component.

The automated tracking control module 201 can include an automated food storage tracking component 211 and an automated food ingredient reordering component 212, among other possible items. The food storage tracking component 211 can be responsible for tracking the contents, location, and use of every food storage cartridge. The food ingredient reordering component 212 can use the levels of food inventory dynamically tracked by the food storage tracking component 211 to reorder automatically any food ingredient when the amount on hand drops below a set threshold. For example, the food storage tracking component 211, which can also be called an inventory control component, can facilitate the presence of minimum inventory levels of food storage cartridges in the food storage matrix by automatically ordering more food storage cartridges for the food storage matrix when an amount of food storage cartridges in the food storage matrix falls below a minimum amount. The automated storage module 202 can include a recipe storage component 213, a cooking procedures component 214, and other storage component 215. The recipe storage component 213 can include known recipes for many different meals and dishes, while the cooking procedures component can include the order of ingredients to be added to dish preparation, as well as the times and temperatures for mixing and cooking of the ingredients at different stages during dish preparation.

The terminal control module 203 can include one or more operator terminals 220 and one or more meal ordering terminals 221. Each terminal 220, 221 can have various user GUIs appropriate for the specific functions provided. Operator terminals 220 can generally be reserved for the use of the system operator or other kitchen or facility personnel, while meal ordering terminals 221 may be made available to facility staff as well as patrons desiring to order fresh meals or dishes to be prepared. Meal ordering terminals 221 can be terminals located at a physical establishment, such as a restaurant or cafeteria, and/or can be terminals or even software modules that can be used remotely on home computers or mobile devices to order meals for takeout or delivery, for example. In some embodiments, the system can accept remote meal orders but may prioritize orders taken locally at the establishment when the system is busy, such as during peak meal hours. The meal ordering component can include a set of meal preparation parameters that include various items, such as meal ingredients, food storage cartridge identifiers, cooking operation sequences, food heating times, and food mixing times, among other possible items.

The system back end module 204 can include a food storage matrix controller 240 as well as a manipulator controller 250, among other possible items. The food storage matrix controller 240 can control all operations specific to a food storage matrix, such as the automated loading of food storage cartridges, temperature measurement and operation of refrigeration units, and the tracking of food storage cartridges and contents at the matrix. The manipulator controller can control a number of functions and submodules, such as a basket mover 251, an actuator controller 255, and a basket rotator 256, among other possibilities. Each of these functions can involve the robotic movement of a basket or actuator located at the basket, further details for which are provided below.

The system front end module 205 can include a conveyer controller 230, which may include a submodule for a diverting arm controller 235, a gripper controller, a catapult arm controller 270, and a cooking receptacle controller 280, among other possible controller and items. Each of these controllers or submodules can similarly control functions with respect to the robotic movement of a food storage cartridge or the cooking and preparation of meals and other food products, further details for which are also provided below.

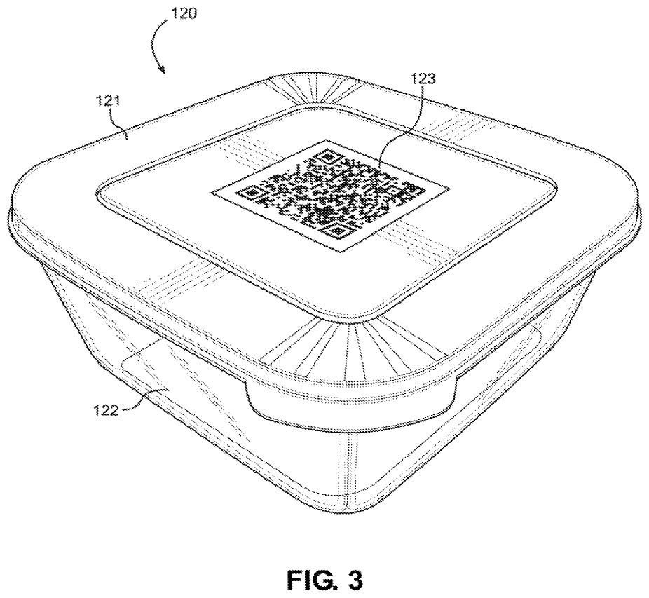

FIG. 3 illustrates in front perspective view an exemplary food storage cartridge for an automated food storage and meal preparation system. Food storage cartridge 120 can be reusable or disposable and can include a lid 121 that removably attaches to and seals with a container 122 to keep individual food portions fresh and ready to be used by the overall system. In various embodiments, food storage cartridge 120 may not include a lid, and the overall system can be operable with food storage cartridges that have lids and/or food storage cartridges that do not have lids. In addition, one or more containers 122 can include internal sections that store food contents separately from each other. The overall system can include many such food storage cartridges, with each one being able to store prepared food portions. A unique machine-readable identifier 123 can be used to identify every specific food storage cartridge 120, such that the system can track the location of every food storage cartridge and know its current contents. For example, unique identifier 123 can be contained in a bar code, QR code, RFID component, or the like. One or more robotically controlled components of the overall system can include a reader that is able to read the unique identifier 123 on every food storage cartridge 120 during handling. In this manner, data and statistics can be readily available to manage food quality, procurement, and stocks, such that a high rate of supply chain performance can be maintained.

Various ingredients can be chopped, sliced, mixed, or otherwise prepared for storage in one or more food storage cartridges 120. Food storage cartridges containing portioned food contents can be stored at appropriate locations in the system and then moved through the system as needed in real time when dish or meal orders are placed that require the food contents from the food storage cartridges. Because prepared food ingredients are stored in food storage cartridges 120, this can result in a virtually unlimited diversity of ingredients with little to no limitations on food product choices, minimal food waste due to better planning, precise food preparation processes, and digital tracking and accounting of the various food contents, no daily cleaning of superfluous kitchen containers, tools, shelves, and items, and detailed digital food supply chain management that can track existing stocks and automatically reorder various different food ingredients as needed over time. Each food storage cartridge 120 can include a single portion of prepped food, which portion can be used in a wide variety of different meals or dishes. Each meal or dish can include prepped food from a combination of different food storage cartridges. For example, a food storage cartridge containing a portion of sliced baked chicken breast can be used for a chicken Caesar salad dish at a salad station, a chicken soup dish at a soup station, or a chicken fettucine dish at a hot bowl station. Each of these dishes would combine the sliced baked chicken breast with prepped food contents from other food storage cartridges during the dish preparation process. Contents of food storage cartridges 120 can be categorized in various ways, such as, for example, proteins, veggies, toppings, bases, sauces, and bouillons. Sauces and bouillons may alternatively be provided by way of other storage and delivery devices, as will be readily appreciated.

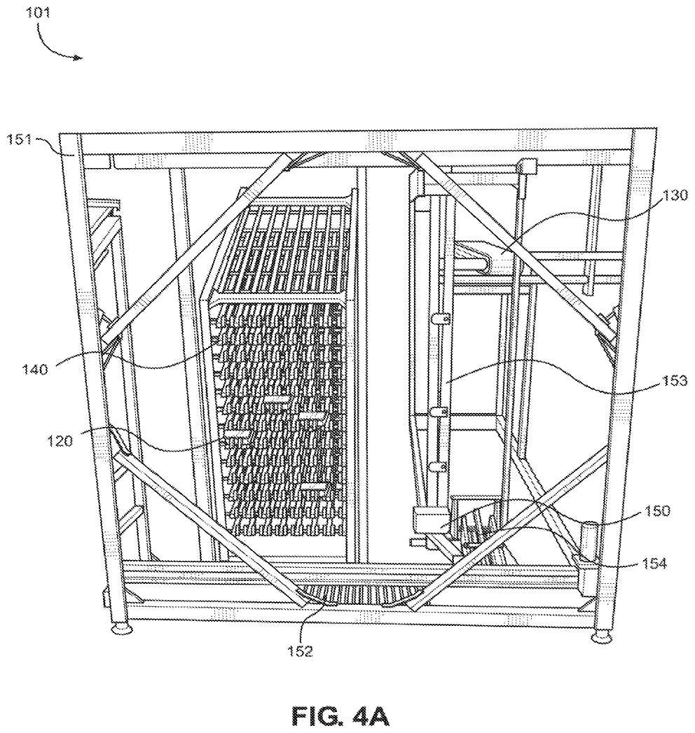

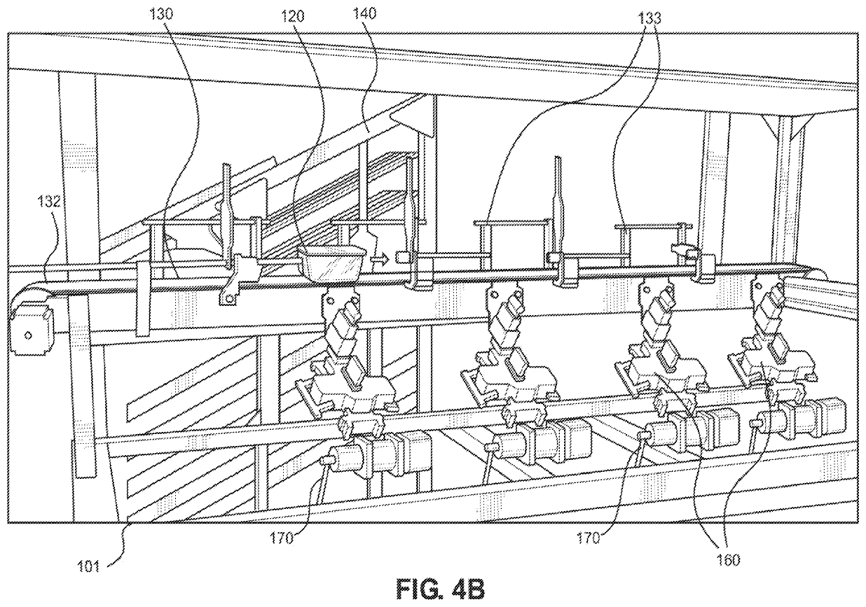

Turning now to FIG. 4A an exemplary food storage matrix, manipulator, and basket for an automated food storage and meal preparation system is illustrated in front perspective view. Automated food storage and meal preparation system 101 can be substantially similar to system 100, albeit with possibly different components and features, and food storage matrix 140, manipulator 150 and basket 154 can form part of a back end of the system 101 as shown. One or more food storage cartridges 120 can be stored in the food storage matrix 140, and one function of the back end portion shown is to move these food storage cartridges 120 from the food storage matrix 140 to the conveyer 130 at the front end of system 101. A manipulator 150 can be robotically controlled to move the basket 154 while carrying a food storage cartridge 120 accordingly. The manipulator 150 and basket 154 can be located within a manipulator frame 151, which also houses a horizontal track 152 and vertical track 153 along which the basket 154 is robotically moved.

Continuing with FIG. 4B, an exemplary conveyer with gates, grippers, and catapult arms for an automated food storage and meal preparation system is shown in front perspective view. Conveyer 130, conveyer gates 133, grippers 160 and catapult arms 170, among other associated components, can represent a back end of system 101 as shown. Food storage cartridges 120 can be transported by the back end of system 101 to a conveyer receiving end 132, where they are then moved down the conveyer 130 to the appropriate conveyer gate 133. From there, food storage cartridges are directed to the gripper 160 and catapult arm 170 of the appropriate module where they are processed further, as detailed below.

### Food Storage Matrix

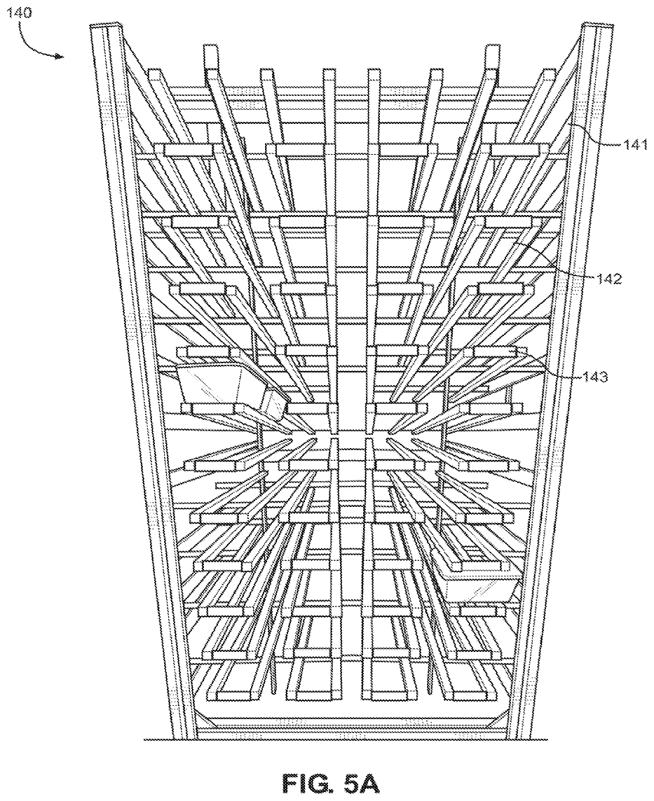

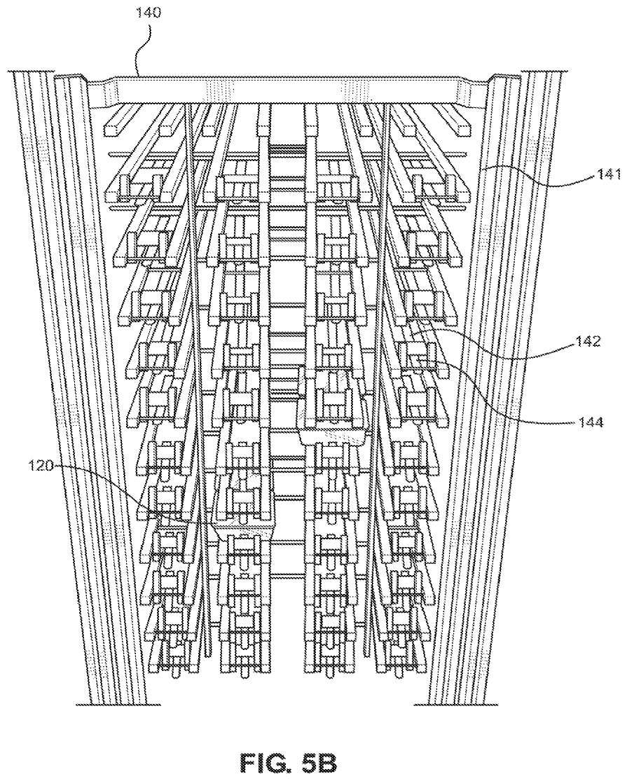

Transitioning to different possible components of an overall automated food storage and meal preparation system, a food storage matrix can have the specific purpose of storing many loaded food storage cartridges in an organized fashion. FIG. 5A depicts an exemplary food storage matrix in rear perspective view. Food storage matrix 140 can have a matrix frame 141 and a plurality of chutes 142 arranged in rows, columns, or both. As shown, chutes 142 can be arranged into four columns and eleven rows, although other amounts for each are also possible. Each chute 142 can hold many food storage cartridges at any given time. For example, each chute 142 may hold about twenty food storage cartridges, such that the overall food storage cartridge holding capacity of food storage matrix 140 as illustrated in FIG. 5A is 880. In various arrangements, it is contemplated that a food storage matrix capacity of about 720 is sufficient for a system operating at full capacity.

Content labels 143 can be located at a loading end of each chute 142 to indicate which food contents belong in each chute 142. Such content labels 143 can have numbers, words, machine readable indicia, or any combination thereof, so as to assist with the automated and/or manual loading of newly packed food storage cartridges. The loading end of each chute can be elevated, such that loaded food storage cartridges slide down the chute due to gravity. One or more refrigeration units (not shown) can be located at or within the food storage matrix 140 in order to keep the food storage cartridges and their stored prepared food contents at an appropriate temperature. Alternatively, or in addition, food storage matrix 140 can be located inside a refrigerated room or region where the temperature can be carefully monitored and controlled.

Food storage matrix 140 can be equipped with at least one reader to facilitate reading unique identifiers of incoming food storage cartridges as they are loaded into the food storage matrix. In various embodiments, this can involve one or more manual reading devices, such as a bar code reader, a QR reader, an RFID reader, a color-coding reader, or the like. Such manually operated reader(s) can be handheld or readily accessible for a user loading food storage cartridges into the food storage matrix. In such arrangements, food storage matrix 140 can be further equipped with a display screen, light array, or other visual indicator that indicates an appropriate chute (e.g., a row and a column) of the food storage matrix for the user to load an incoming food storage cartridge after the reader reads the incoming food storage cartridge. Alternatively, or in addition, each individual chute of food storage matrix 140 can be equipped with a separate reader that automatically reads the unique identifiers of incoming food storage cartridges that are loaded into the chute.

In any such arrangement using manual readers, automated readers, or no readers, an expiration date can be associated with each food storage cartridge unique identifier. In such arrangements, the automated meal preparation system can automatically consider associated expiration dates when selecting a chute for loading a food storage cartridge, or when selecting a food storage cartridge to be taken from the food storage matrix, details of which are provided below, such as in the “Manipulator” section of the present disclosure.

In some embodiments, food storage matrix 140 can be expandable, so as to accommodate for increased business and future capacity needs by a given establishment. Expanding food storage matrix 140 can be accomplished by adding extra chutes, for example. Accordingly, the system can be configured to allow for adding more rows of chutes, more columns of chutes, or both to an existing food storage matrix. For example, the food storage matrix 140 of FIG. 5A can be expanded by adding another column of chutes to make its matrix five columns and eleven rows.

Continuing with FIG. 5B, the exemplary food storage matrix of FIG. 5A with a food storage cartridge in a chute thereof is shown in front perspective view. As shown in this front view, food storage cartridges 120 can slide down each chute 142 of the food storage matrix 140 when loaded to arrive at the front of the chute or up against the last food storage cartridge already in the chute. The dispensing end of each chute 142 is shown in FIG. 5B, and the dispensing ends can be lower than the loading ends shown in FIG. 5A to facilitate the ready sliding of cartridges toward the dispensing end. A passive mechanical cartridge dispenser 144 can be located at the dispensing end of some or all of the chutes 142 in the food storage matrix 140. Each mechanical cartridge dispenser 144 can prevent food storage cartridges 120 from falling out of their chute 142 by default and can be actuated to dispense the frontmost food storage cartridge 120 in the chute, as detailed below.

### Mechanical Cartridge Dispenser

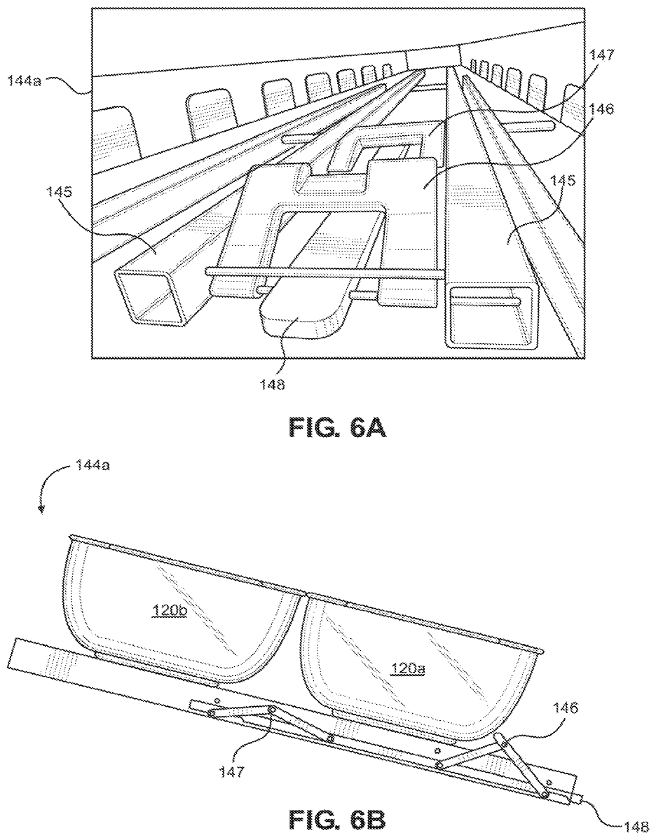

The mechanical cartridge dispenser can have the specific purpose of holding back food storage cartridges and dispensing the cartridges when actuated. FIG. 6A illustrates in front perspective view an exemplary mechanical cartridge dispenser at the dispensing end of a matrix chute for an automated food storage and meal preparation system. Mechanical cartridge dispenser 144a is shown in default position, which prevents the passage of any food storage cartridges. The mechanical cartridge dispenser 144a can be located between elements of a chute track 145 at the dispensing end of a chute, and can include a first blocking element 146, a second blocking element 147, and an actuation stem 148. Each blocking element 146, 147 can have a blocking position and a passing position, and these blocking elements can alternate so that one is blocking while the other is passing at any given time. A variety of shapes and configurations can be used for a passive mechanical cartridge dispenser to function appropriately. For example, both blocking elements 146, 147 can have mechanically linked and pivoting components that are triangular in nature, such that a raised triangle blocks all cartridges while a flattened triangle passes cartridges.

FIG. 6B illustrates in side elevation view the exemplary mechanical cartridge dispenser of FIG. 6A with two food storage cartridges loaded at the dispensing end of its matrix chute. Again, the mechanical cartridge dispenser is shown in its default position 144a with first blocking element 146 being raised to a blocking position and the second blocking element 147 being flattened to a passing position. Actuation stem 148, which can be a passive spring-loaded component, for example, can also be in its default position. The matrix chute belonging to mechanical cartridge dispenser 144a can be loaded with multiple food storage cartridges, which can include a first food storage cartridge 120a located at the front of the chute and a second food storage cartridge 120b located behind the first food storage cartridge. Additional food storage cartridges (not shown) may also be backed up in the chute behind the second food storage cartridge 120b. Since the first blocking element 146 is in its blocking position, it blocks the first food storage cartridge 120a from passing. Although the second blocking element 147 is flattened into its passing position such that it does not block the second food storage cartridge 120b, the first food storage cartridge 120a blocks the second food storage cartridge 120b and all other food storage cartridges in the chute behind it.

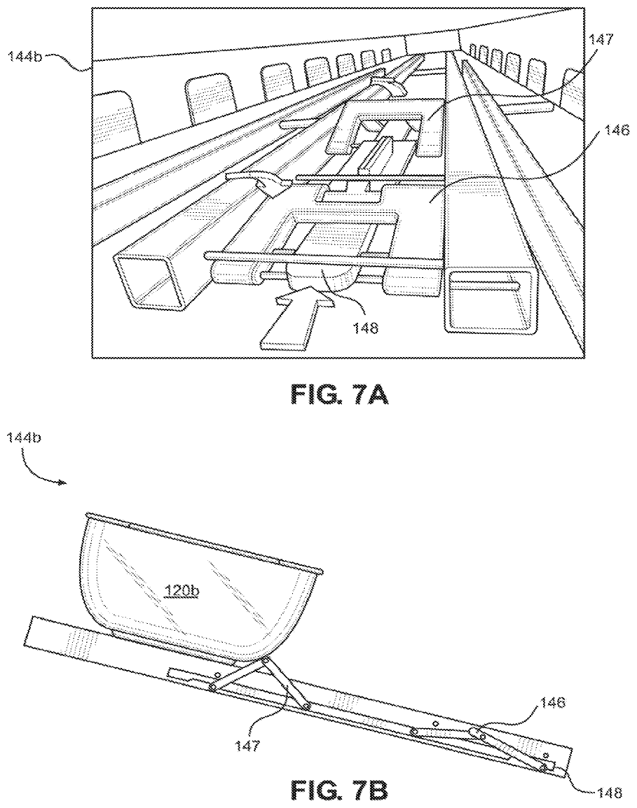

Continuing with FIG. 7A the exemplary food storage cartridge of 6A is shown in front perspective view as being manually actuated. When the actuation stem 148 is pressed, the mechanical cartridge dispenser of FIG. 6A moves into its actuated position 144b. As such, the first blocking element 146 moves into its flattened passing position while the second blocking element 147 is raised to its blocking position. A food storage cartridge located at the front of the chute is then passed out of the chute past flattened first blocking element 146 by force of gravity, while all other food storage cartridges remaining in the chute are then blocked by the raised second blocking element 147.

This is shown in FIG. 7B, which illustrates in side elevation view the exemplary mechanical cartridge dispenser of FIG. 6B after actuation. As shown, the mechanical cartridge dispenser has been actuated to position 144b by pushing on actuation stem 148. The first blocking element 146 is in a flattened passing position, while the second blocking element 147 is in a raised blocking position. The first food storage cartridge 120a has been passed out of the chute, while the second food storage cartridge 120b and all others behind it remain in the chute as blocked by raised second blocking element 147.

### Actuator

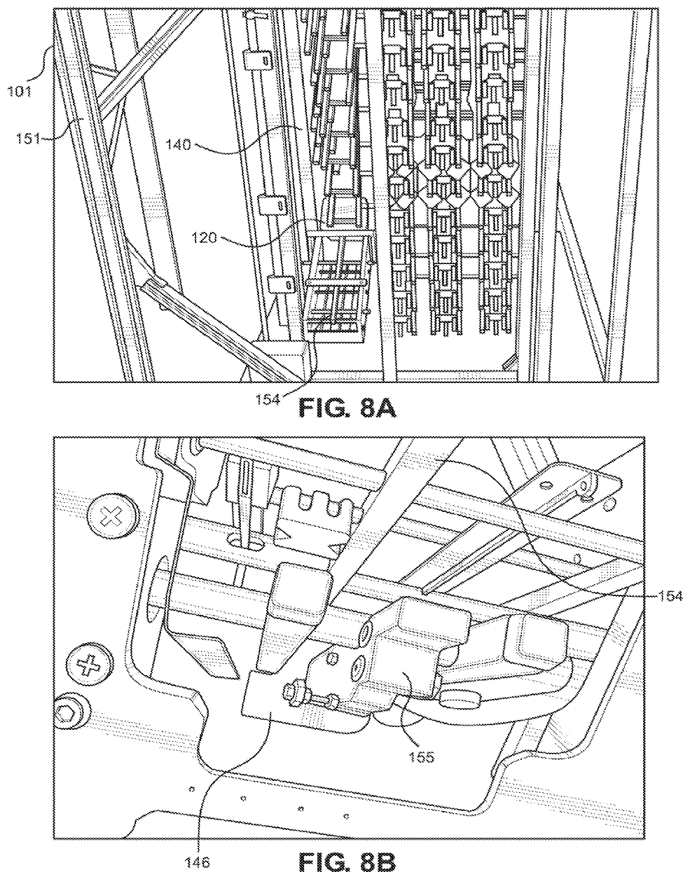

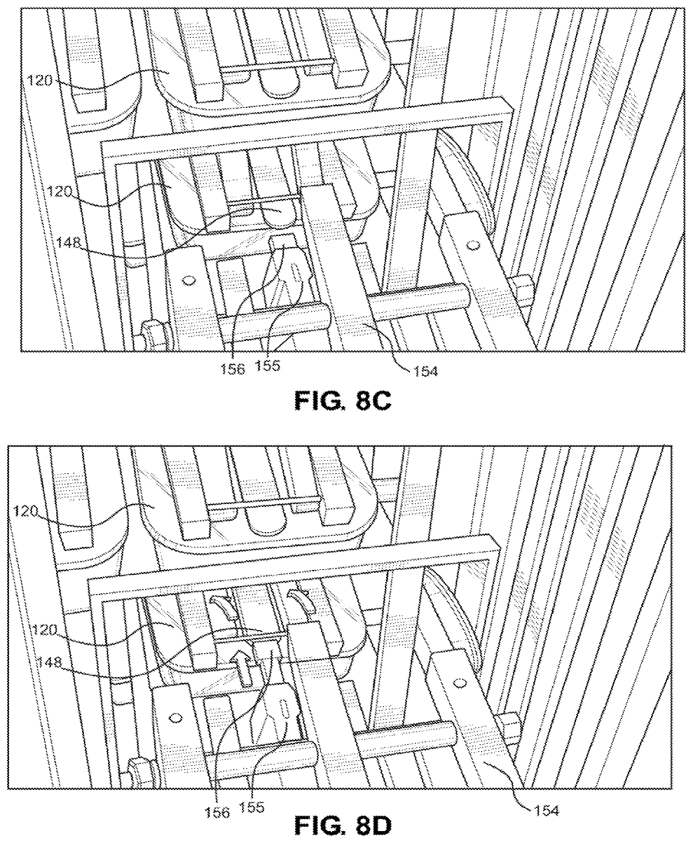

Another system feature involves an actuator, which can have the specific purpose of actuating a mechanical cartridge dispenser in order to release a food storage cartridge from a chute in the food storage matrix. FIG. 8A illustrates in front perspective view an exemplary empty basket positioned at the dispensing end of a food storage matrix chute. Again, system 101 can include a food storage matrix 140 having multiple chutes, some or all of which can contain various food storage cartridges 120. A manipulator located within a manipulator frame 151 can position a basket 154 at the dispensing end of a chute to receive the front food storage cartridge 120 therefrom. When the basket 154 is in position, an actuator located at the basket can robotically actuate an actuation stem at the front of the chute.

FIG. 8B illustrates in bottom perspective view an exemplary actuator at the bottom of the basket of FIG. 8A. An actuator 155 can be coupled to or integrated inside the basket 154, and can be robotically controlled at the appropriate time to press the actuation stem at the front of the chute in order to actuate the mechanical cartridge dispenser and move its first blocking element 146 to a flattened passing position. A plunger or other suitable component coupled to the actuator 155 can be used to push on the actuation stem. Upon actuation, the food storage cartridge at the front of the chute is then delivered from the food storage matrix into the basket 154.

FIG. 8C provides a close up in top perspective view of an exemplary basket and actuator positioned at food storage matrix chute prior to actuation. Food storage cartridge 120 can be blocked by the front blocking component of a mechanical cartridge dispenser in default position. The basket 154 can be moved by the manipulator to a receiving position at the dispensing end of a chute, and an actuator plunger 156 extending from the actuator 155 can be in position to be pushed into the actuation stem 148 of the mechanical cartridge dispenser. For purposes of illustration, no food storage cartridge is presently in the chute that is about to have its actuation stem 148 pushed.

FIG. 8D also illustrates in close up top perspective view the exemplary basket and actuator of FIG. 8C after actuation. As shown, the actuator has been robotically controlled to push the actuator plunger into the actuation stem such that the mechanical cartridge dispenser of the chute is actuated. When a food storage cartridge is at the front of the chute, such a cartridge would then be passed into the basket by way of such actuation. Although a robotically controlled actuator has been shown and described for purposes of illustration, it will be appreciated that a passive actuating component may alternatively be used for actuation purposes. For example, a spring-loaded plunger may be coupled to the basket and can be activated in a purely mechanical fashion when the basket is properly located at a chute.

### Manipulator

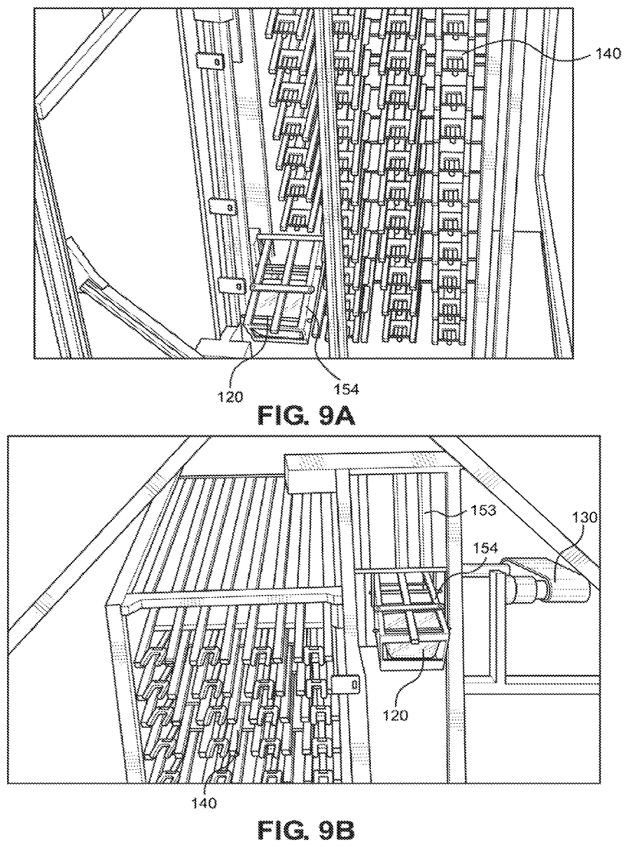

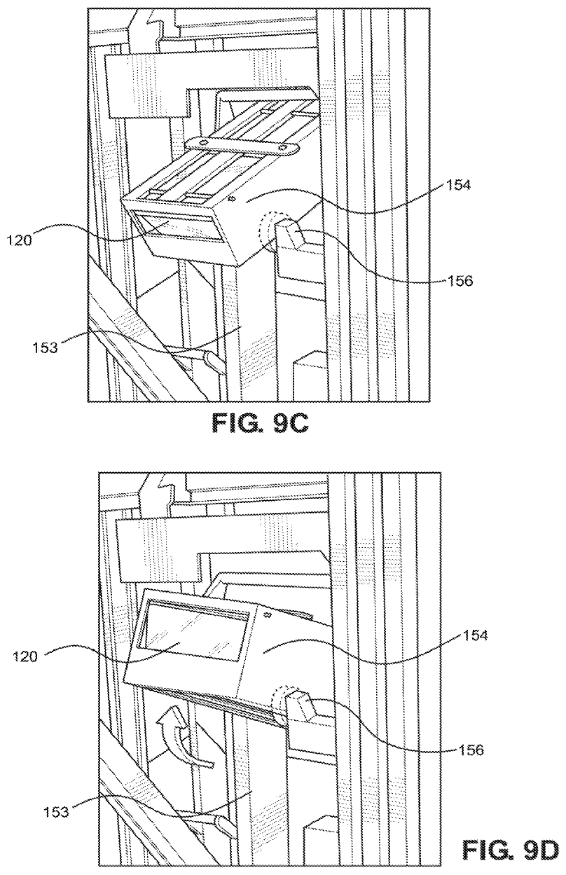

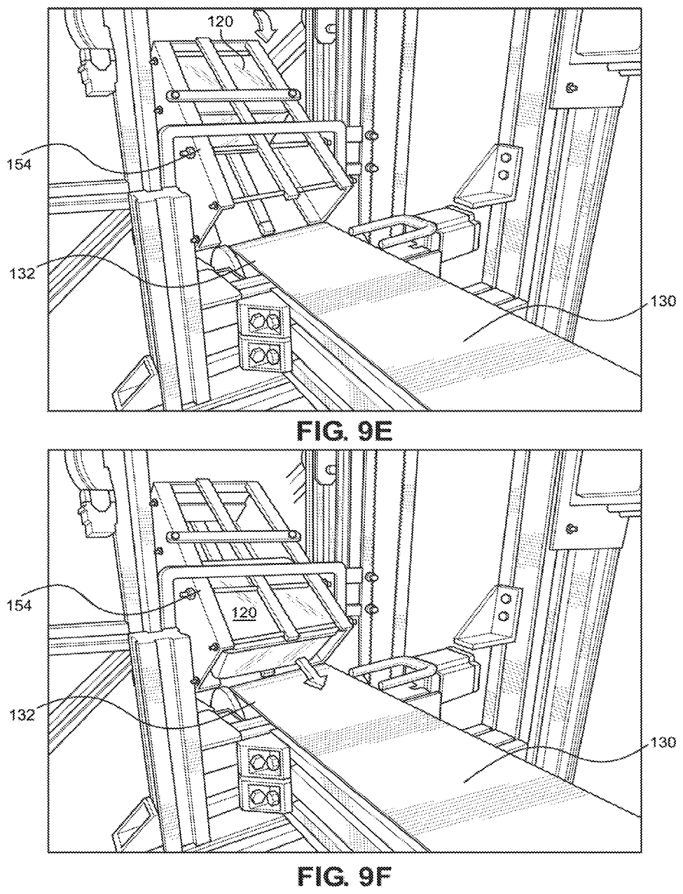

Another system feature can be a manipulator, which can have the specific purpose of moving a basket containing a food storage cartridge from a chute in the food storage matrix to a conveyer or other transport apparatus. The manipulator can also rotate the basket to dispense the food storage cartridge from the basket to a receiving end of the conveyor. FIG. 9A illustrates in front perspective view the exemplary configuration of FIG. 8A with a food storage cartridge 120 from the food storage matrix 140 dispensed into the basket 154. This can be the result of moving the basket 154 to the dispensing end of the chute and actuating the mechanical cartridge dispenser on the chute.

FIG. 9B illustrates in front perspective view the exemplary basket of FIG. 9A transporting the food storage cartridge therein. As shown, the basket 154 contains the received food storage cartridge 120 and is moving from the food storage matrix 140 to the receiving end of conveyer 130. Vertical movement of the basket can take place along vertical track 153 that slides horizontally with the basket within the manipulator frame, and this combined horizontal movement can take place along a horizontal track (shown in FIG. 4A) at the bottom of the manipulator frame. Movement of the basket 154 can be vertical and then horizontal or can be both simultaneously.

Of course, the manipulator can also be used to move the basket 154 into position to receive a food storage cartridge 120 from the food storage matrix 140 in the first place. For example, a default position for the manipulator and basket can be that which is shown in FIG. 4A. Upon receiving a new meal or other food preparation order, the manipulator can then move the basket from this default position to the front of the appropriate chute in the food storage matrix in order to receive a food storage cartridge containing an appropriate food item to fill the new food order.

FIG. 9C illustrates in side perspective view the exemplary basket with food storage cartridge of FIG. 9B at the dispensing end of a conveyer. Basket 154 can be at an upward tilted position such that the food storage cartridge 120 remains in the basket 154. In fact, this same upward tilted position can be constant from the time that the food storage cartridge is received from the food storage matrix until the basket is positioned at the conveyer, as shown. Movement along the vertical track 153 can take place to accurately position the basket 154 at the conveyer, and a basket rotator 156 can then be robotically controlled to rotate the basket 154 downward such that the food storage cartridge 120 slides out of the basket opening where it was received. FIG. 9D illustrates in side perspective view the exemplary basket 154 of FIG. 9C rotated downward to dispense the food storage cartridge 120 onto a conveyer.

FIG. 9E depicts the rotated basket with food storage cartridge of FIG. 9D at the receiving end of a conveyer in front perspective view. As shown, the basket 154 has just rotated downward such that the food storage cartridge 120 is beginning to slide down the basket 154 to be dispensed at the receiving end 132 of conveyer 130. This is just a different view of the same configuration shown in FIG. 9D. Next, FIG. 9F also illustrates in front perspective view the exemplary rotated basket of FIG. 9E with the food storage cartridge passing onto the conveyer. As shown, food storage cartridge 120 is sliding down the basket 154 and is just passing through conveyer opening 131 in front of conveyer receiving end 132.

### Conveyer and Buffer Queue

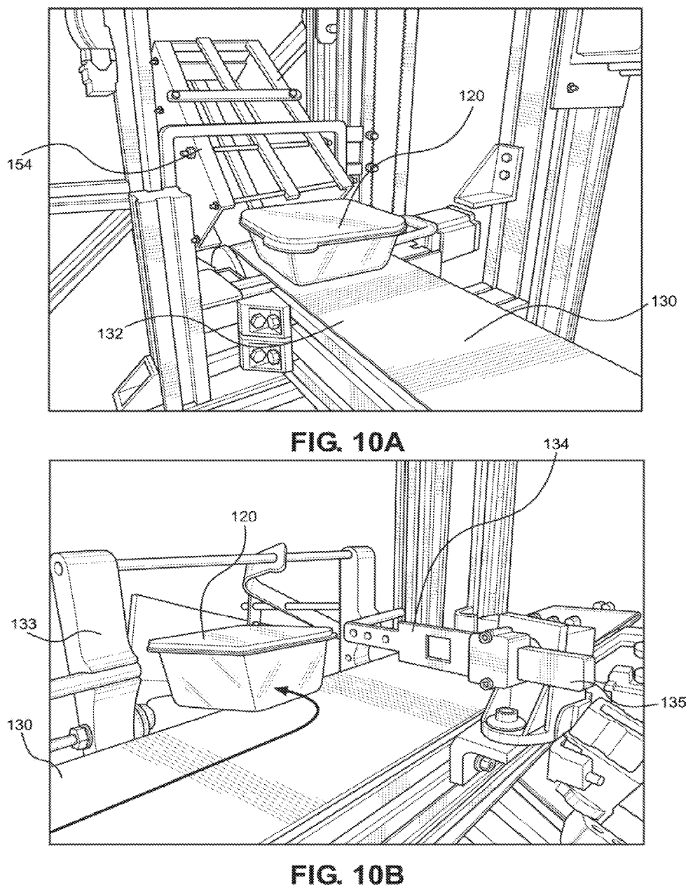

Transitioning to the front end of the overall system, a conveyer can have the specific purpose of moving food storage cartridges to different gates, while a buffer queue can extend from each gate and have the specific purpose of guiding food storage cartridges to a gripper. FIG. 10A illustrates in front perspective view the exemplary rotated basket and food storage cartridge of FIG. 9F. As shown, basket 154 has dispensed food storage cartridge 120 onto the receiving end 132 of conveyer 130. A belt or other moving component on conveyer 130 can then transport the food storage cartridge to the appropriate downstream conveyer gate.

FIG. 10B illustrates in side perspective view an exemplary gate and diverting arm along the conveyer of FIG. 10A. Conveyer 130 can have several conveyer gates 133 that help to direct the moving food storage cartridges to the appropriate buffer queues. Each buffer queue can have its own conveyer gate 133 at the top, such that the number of conveyer gates 133 can match the number of buffer queues and system stations. This can range from four to ten gates, or some alternative amount as may be desired for a given system. A diverting arm 134 can extend by way of a diverting arm rotator 135 over the conveyer 130 to direct a moving food storage cartridge to the appropriate conveyer gate 133.

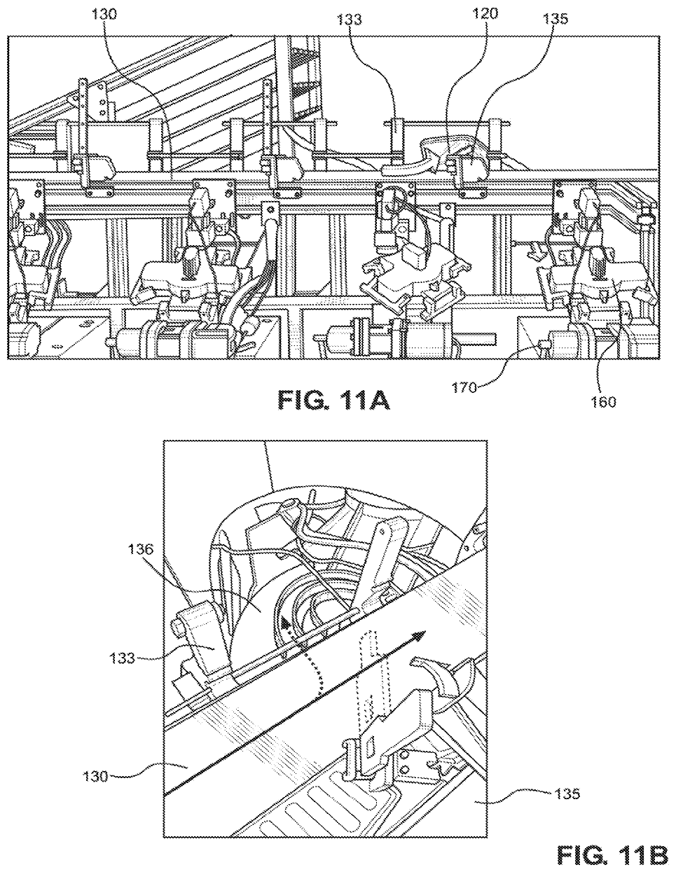

FIG. 11A illustrates in front perspective view an exemplary conveyer with four gates, grippers, and catapult arms, with a food storage cartridge being diverted through the gate of FIG. 10B. As shown, food storage cartridge 120 has traveled down conveyer 130 to conveyer gate 133, where it has been diverted into the gate by way of a diverting arm controlled by diverting arm rotator 135. The food storage cartridge will then pass down a buffer queue to arrive at a gripper 160. An exemplary buffer queue at the conveyer gate of FIGS. 10B and 11A is shown in top perspective view in FIG. 11B. Buffer queue 136 can be a downward spiral path that extends from conveyer gate 133. Diverting arm rotator 136 can rotate a diverting arm at the appropriate time to divert a passing food storage cartridge from the conveyer 130 through the conveyer gate 133 and down the spiral buffer queue 136, where one or more food storage cartridges can queue for subsequent processing by a gripper and catapult arm. A blocking lever (not shown) can be robotically controlled at the bottom of buffer queue 136 to release one food storage cartridge 120 at a time into the gripper below.

In some arrangements, one or more reception components can receive empty and used food storage containers. These reception components can be large bins or other containers where empty food storage containers can be stacked, such as for disposal or later reuse. These reception components can be placed at various locations where used food storage containers typically collect, such as, for example, a final end of conveyor 130 and/or beneath each catapult arm.

### Gripper and Catapult Arm

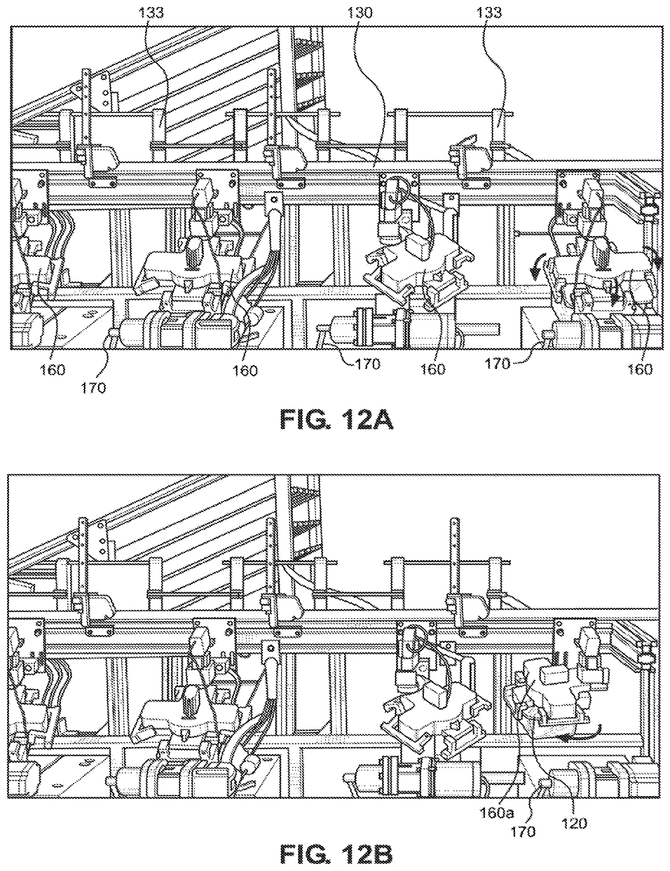

Positioned at the end of a buffer queue, a gripper can have the specific purpose of gripping and moving a food storage cartridge to an unpacking position, while a catapult arm can have the specific purpose of operating with the gripper to separate the lid from the container of the food storage cartridge and then flip the container over to empty the food contents therefrom. FIG. 12A illustrates in front perspective view the conveyer of FIG. 11A with the food storage cartridge being gripped by an exemplary gripper at the end of the buffer queue of FIG. 11B according to one embodiment of the present disclosure. Four separate stations can be distributed along conveyer 130, and each station can have its own conveyer gate 133, buffer queue, gripper 160, and catapult arm 170. As shown, food storage cartridge 120 has been delivered into the gripper at the far right station of FIG. 12A. Once a food storage cartridge 120 has entered a gripper, four gripper latches can move to latch onto and hold the food storage cartridge for subsequent processing.

FIG. 12B illustrates in front perspective view the food storage cartridge moved to an unpacking position by the gripper of FIG. 12A. The gripper can have a rotation axis that allows the gripper to be moved from a receiving position to an unpacking position 160a, as shown. The gripper 160a can hold the food storage cartridge 120 through this rotational movement to the unpacking position, where the catapult arm 170 can prepare to engage with the food storage cartridge 120 and gripper.

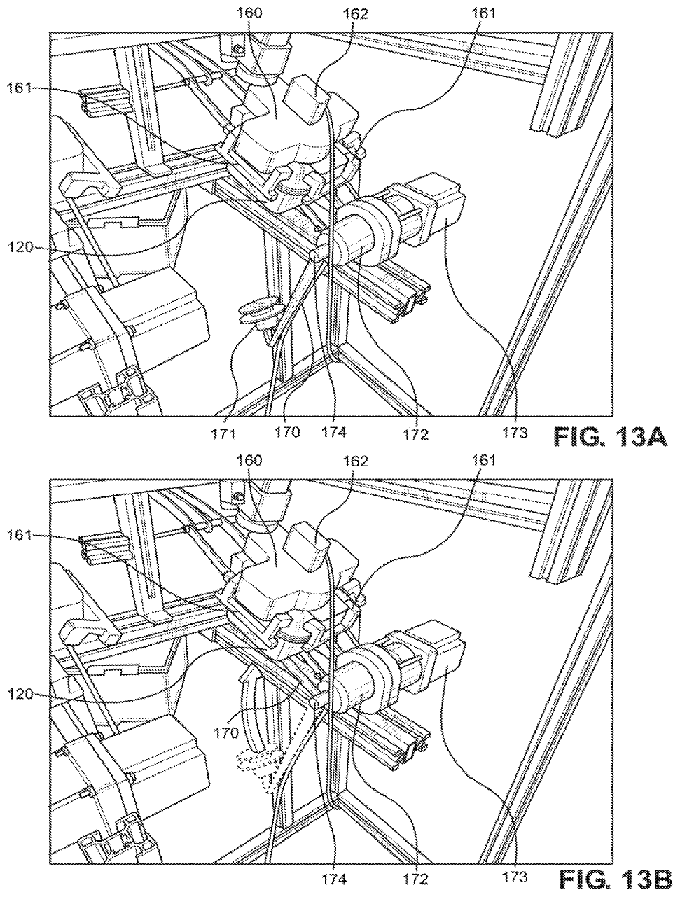

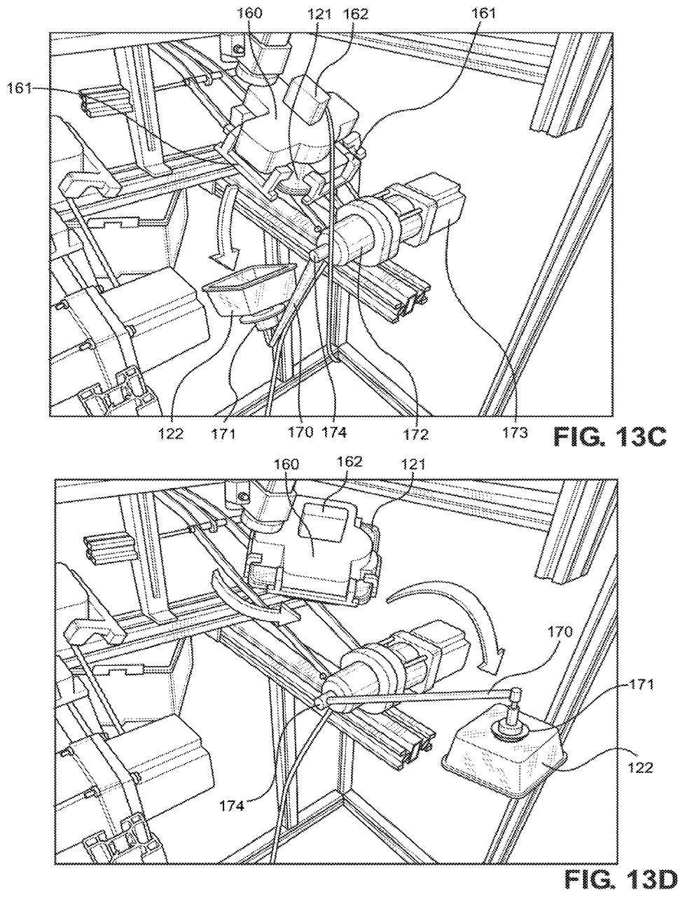

FIG. 13A illustrates in side perspective view an exemplary catapult arm prior to contacting a food storage cartridge held by the gripper. Gripper 160 can include four gripper latches 161 that are controlled by a gripper motor 162 to move and latch onto a food storage cartridge 120 that is received into the gripper 160. A catapult arm 170 can be a rotating shaft that can include a suction cup 171 or other suitable removable attachment component at one end, as well as a catapult arm rotator 172 and catapult motor 173 configured to control the rotational movement of the catapult arm. An arm to rotator coupling 174 can couple the catapult arm 170 to the catapult arm rotator 172. When the catapult arm 170 rotates to engage the food storage container 120 in an unpacking position, a vacuum can be applied through an inner passage within the catapult arm 170 to the suction cup 171. The vacuum can then cause the catapult arm to hold a bottom surface of the food storage cartridge 120.

FIG. 13B illustrates in front perspective view the catapult arm and gripper of FIG. 13A holding the food storage cartridge. In particular, the gripper 160 can hold the lid of the food storage cartridge 120 while the suction cup 171 of the catapult arm 170 can hold the bottom of the container of the food storage cartridge 120. Unpacking of the food storage cartridge 120 can then take place while both of the gripper 160 and catapult arm 170 hold the food storage cartridge in the unpacking position. FIG. 13C illustrates in front perspective view the gripper moving the separated food storage cartridge lid away from the food storage cartridge container held by the catapult arm. With the gripper 160 firmly gripping the lid 121 of the food storage cartridge and the catapult arm 170 firmly holding the container 122, the gripper can then be robotically moved from the unpacking position back toward its receiving position. This can result in the lid 121 being removed from the container 122 such that the food contents of the food storage cartridge can be unpacked. Of course, in embodiments where food storage cartridge 120 has no lid, then operation of the gripper 160 need not be concerned with removing a lid.

FIG. 13D illustrates in front perspective view the food storage cartridge container being flipped over by the catapult arm. While the gripper 160 holds the lid 121 and moves it out of the way back into the receiving position of the gripper, the catapult arm 170 can then “unpack” or empty the contents of the container 122. This can be accomplished by rotating the catapult arm 170 forward until the container 122 is completely upside down while the suction cup 171 maintains suction on the container. The food contents of the container 122 then fall into a dish, cooking receptacle, or other item.

### Food Preparation Receptacle

Lastly, a food preparation receptacle can have the specific purpose of receiving food contents emptied from one or more food storage cartridges by the catapult arm and preparing the received food contents for a finished dish. Food preparation in the food preparation receptacle can include combining the food contents, cooking the food contents in the case of soups or hot bowls, and optionally mixing the food contents, such as while cooking. For salad modules, the food preparation receptacle can be a simple salad mixing bowl or container. For soup modules, the food preparation receptacle can be a soup cooking pot with a dispensing spout or outlet. For hot bowl modules, the food preparation receptacle can be a cooking receptacle. A cooking receptacle can be a part of the overall system or may be its own standalone unique embodiment in some arrangements.

In some embodiments, one or more display screens can be located proximate one or more of the food preparation receptacles in the system. Each such display screen can be configured to provide information regarding a dish being prepared in a respective food preparation receptacle. Such display information can include, for example, an order number of the dish being prepared, a status of the dish being prepared, and the amount of time left until the dish being prepared is finished. Other informational items can also be displayed at such display screen(s), as will be readily appreciated.

In various arrangements, one or more quality control cameras can be placed about the system to facilitate monitoring of appropriate quality levels during automated food preparation and/or final dish completion and presentation. For example, a camera can be located at one or more of the food preparation receptacles at each food preparation module. These cameras can facilitate the remote viewing and monitoring of prepared food that exits the food preparation modules. Alternatively, automated visual inspection programs can be utilized to detect irregularities or improper food colors or completion levels as finished food exits the food preparation modules. In addition, one or more thermometers or other temperature sensors can be used with different food preparation receptacles. For example, each cooking receptacle can have an internal temperature sensor to monitor and ensure proper cooking temperatures.

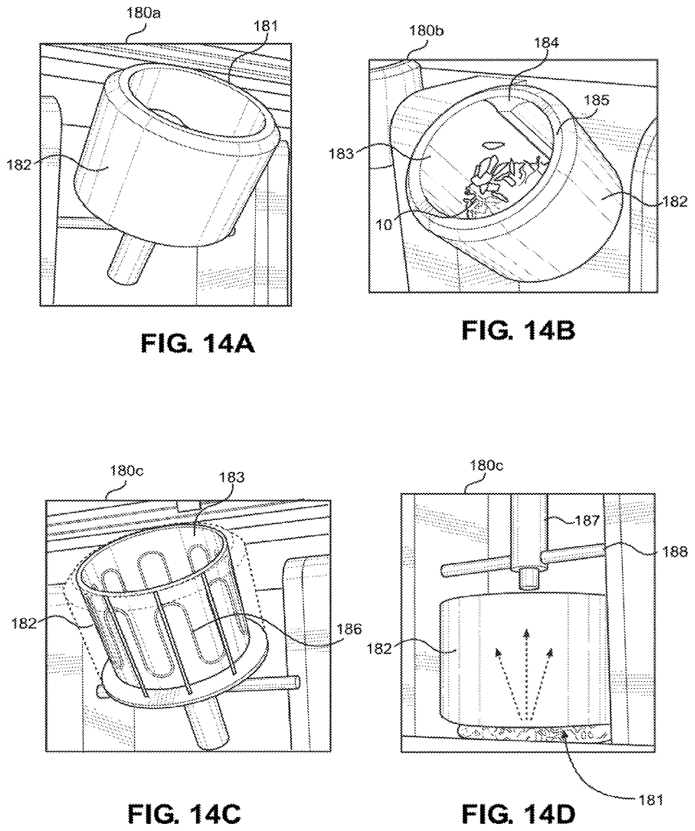

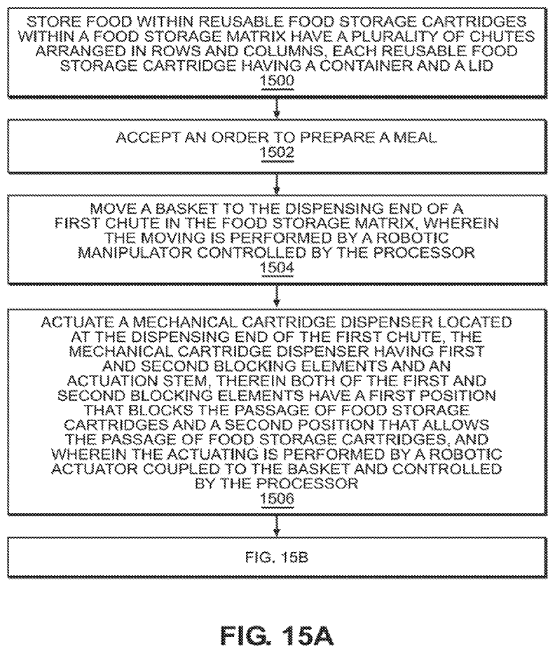

Since the more complex type of food preparation receptacle tend to be cooking receptacles for hot bowl modules, further details will now be provided specifically for such cooking receptacles. FIG. 14A illustrates in front perspective view an exemplary cooking receptacle for an automated food storage and meal preparation system. Cooking receptacle 180a is shown as upright and ready to receive food contents emptied therein, such as those falling from one or more food storage containers flipped over by a catapult arm. Cooking receptacle 180a can include an upper opening 181 and one or more external sidewalls 182. As shown, cooking receptacle can be circular, such that there is a single external sidewall 182.

FIG. 14B illustrates in front perspective view the cooking receptacle of FIG. 14A. Cooking receptacle 180b is shown after receiving food 10 and tilting in preparation for food mixing and cooking. Cooking receptacle 180b can have one or more external sidewalls 182, one or more internal sidewalls 183, a protrusion 184 extending from an internal sidewall, and a bottom 185. Again, the cooking receptacle 180b can be circular, such that there is a single internal sidewall 183 contained within the single external sidewall 182. The internal sidewall 183 can be coated by a non-stick coating. The protrusion 184 can be affixed to or integrally formed with the internal sidewall 183 and can function to mix the deposited food contents and stir them during cooking. This can take place due the cooking receptacle 180b spinning during food preparation and cooking. In addition to spinning, the food receptacle 180b can also be configured for full rotation from an upright to an upside-down position.

FIG. 14C illustrates in front perspective view the cooking receptacle of FIG. 14B spinning and cooking the received food. Cooking receptacle 180c can remain tilted as shown during the spinning and cooking process. A heating element 186 can be coaxially located between the external sidewall 182 and internal sidewall 183, which together form a cylindrical portion of the cooking receptacle 180c. In this manner, the entire inner surface of cooking receptacle 180c can be quickly and efficiently heated. For example, the inner surface can be heated from about 70° F. up to any desired temperature approaching about 480° F. This can take about 30 seconds from a “stand by” mode, and the inner surface can remain heated for several minutes as needed for the particular dish being cooked. The heating element 186 can be a direct electric heater, which can be simpler, cheaper, more energy efficient, and better at heating than an induction heater or other alternative heating elements. In some embodiments, the cooking receptacle 180c can be shaken rather than or in addition to spinning during the cooking process.

FIG. 14D illustrates in front perspective view the cooking receptacle of FIG. 14C fully rotated upside down for cleaning after cooking and dispensing the received food according to one embodiment of the present disclosure. After dispensing the cooked food contents therein, the cooking receptacle 180d can be fully rotated upside down such that upper opening 181 faces downward. This can be accomplished by way of a rotational shaft 188 that is robotically controlled to tilt and fully rotate the cooking receptacle 180d at appropriate times. The cooking receptacle can be coupled to the rotational shaft 188 by way of a coupling shaft 187. In some arrangements, the coupling shaft may also include and/or shaking elements that provide spinning and/or shaking of the cooking receptacle 180d during the prior cooking process. While upside down, the cooking receptacle 180d can be cleaned by an automated cleaning process, which can include various steam cleaning components (not shown).

It will be appreciated that cooking receptacle 180 has been shown for purposes of illustration since it can be the most complex end component in a system module. As noted above, other modules besides hot bowl modules can also include salad modules and soup modules. Rather than have a cooking receptacle as the end component, a salad module can have a mixing bowl or a simple bowl or plate as its end component, while a soup module can have a soup cooking pot that may be similar to cooking receptacle 180. In some arrangements, cooking receptacle 180 may be designed to cook soup dishes as well as hot bowl dishes. Physical differences between the different types of modules may also be designed as desired. For example, since a salad module is simpler in comparison to a hot bowl module, a spinning and rotating cooking receptacle and the inherent complexity and depth of these components can be replaced with a simple collection bowl or dish that can be elevated higher than the final bowl or dish of a hot bowl module.

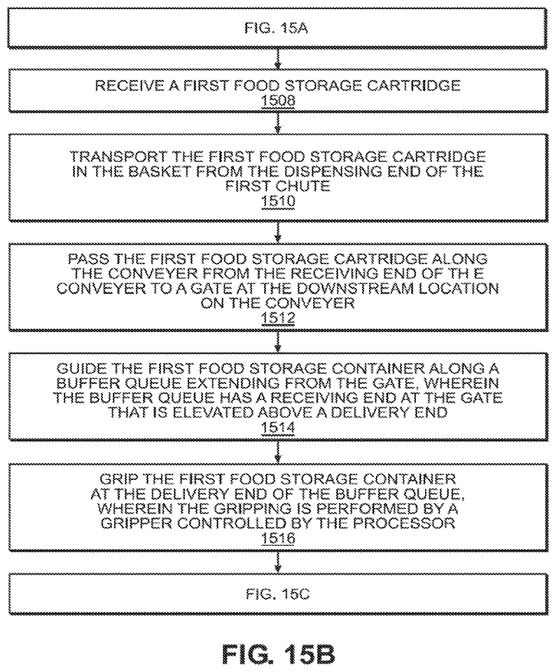

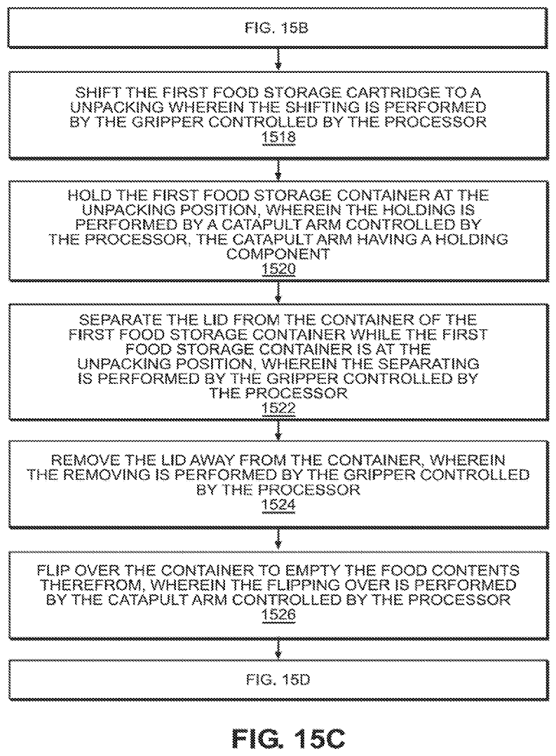

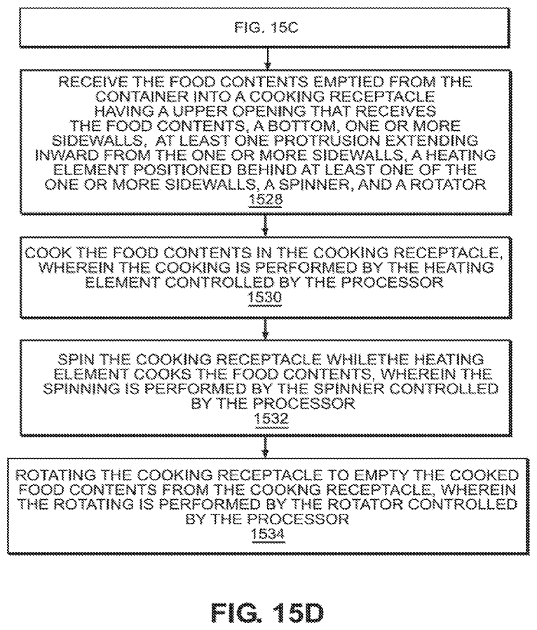

FIGS. 15A-15D illustrate example flow charts of processes for operating a meal preparation system. As illustrated in example flow diagrams of FIGS. 15A-15C, at block 1500, the meal preparation system can store food within food storage cartridges within a food storage matrix having a plurality of chutes arranged in rows and columns, each food storage cartridge having a container and a lid. In one example, at least some of the plurality of chutes include a loading end elevated above a dispensing end.

At block 1502, the meal preparation system can accept at a processor an order to prepare a meal. The meal can include food stored within the food storage matrix.

At block 1504, the meal preparation system can move a basket to the dispensing end of a first chute in the food storage matrix. The movement can be performed by a robotic manipulator controlled by the processor.

At block 1506, the meal preparation system can actuate a mechanical cartridge dispenser located at the dispensing end of the first chute, the mechanical cartridge dispenser having first and second blocking elements and an actuation stem. Both of the first and second blocking elements can have a first position that blocks the passage of food storage cartridges and a second position that allows the passage of food storage cartridges. The actuating can be performed by a robotic actuator coupled to the basket and controlled by the processor.

At block 1508, the meal preparation system can receive a first food storage cartridge into the basket when the mechanical cartridge dispenser is actuated, the first food storage cartridge having food contents.

At block 1510, the meal preparation system can transport the first food storage cartridge in the basket from the dispensing end of the first chute to a receiving end of a conveyer The transporting can be performed by the robotic manipulator controlled by the processor.

At block 1512, the meal preparation system can pass the first food storage cartridge along the conveyer from the receiving end of the conveyer to a gate at a downstream location on the conveyer.

At block 1514, the meal preparation system can guide the first food storage container along a buffer queue extending from the gate. The buffer queue can have a receiving end at the gate that is elevated above a delivery end.

At block 1516, the meal preparation system can grip the first food storage container at the delivery end of the buffer queue. The gripping can be performed by a gripper controlled by the processor.

At block 1518, the meal preparation system can shift the first food storage cartridge to an unpacking position. The shifting can be performed by the gripper controlled by the processor.

At block 1520, the meal preparation system can hold the first food storage container at the unpacking position. The holding can be performed by a catapult arm controlled by the processor, the catapult arm having a holding component.

At block 1522, the meal preparation system can separate the lid from the container of the first food storage container while the first food storage container is at the unpacking position. The separating can be performed by the gripper controlled by the processor.

At block 1524, the meal preparation system can remove the lid away from the container. The removing can be performed by the gripper controlled by the processor.

At block 1526, the meal preparation system can flip over the container to empty the food contents therefrom. The flipping over can be performed by the catapult arm controlled by the processor.

Further, as illustrated in FIG. 15D, at block 1528, the meal preparation system can receive the food contents emptied from the container into a cooking receptacle, the cooking receptacle having an upper opening that receives the food contents, a bottom, one or more sidewalls, at least one protrusion extending inward from the one or more sidewalls, a heating element positioned behind at least one of the one or more sidewalls, a spinner, and a rotator.

At block 1530, the meal preparation system can cook the food contents in the cooking receptacle. The cooking can be performed by the heating element controlled by the processor.

At block 1532, the meal preparation system can spin the cooking receptacle while the heating element cooks the food contents. The spinning can be performed by the spinner controlled by the processor.

And at block 1534, the meal preparation system can rotate the cooking receptacle to empty the cooked food contents from the cooking receptacle. The rotating can be performed by the rotator controlled by the processor.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

1. An automated meal preparation system, comprising:
a food storage matrix including a plurality of chutes arranged in rows, columns, or both, the plurality of chutes being configured to hold a plurality of food storage cartridges, wherein at least some of the plurality of chutes include a loading end and a dispensing end;
a mechanical cartridge dispenser located at the dispensing end of one or more of the plurality of chutes, the mechanical cartridge dispenser having blocking elements and an actuation stem, wherein the blocking elements have a blocking position that blocks the passage of food storage cartridges and a passing position that allows the passage of food storage cartridges; and
a basket that receives one or more food storage cartridges when the basket is positioned at the dispensing end of one of the plurality of chutes.

2. The automated meal preparation system of claim 1, further comprising:
the plurality of food storage cartridges, wherein each food storage cartridge is reusable and includes a container, a lid, and a unique identifier that is machine readable by the automated meal preparation system.

3. The automated meal preparation system of claim 1, wherein at least some of the plurality of chutes have the loading end elevated higher than the dispensing end.

4. The automated meal preparation system of claim 1, wherein each mechanical cartridge dispenser is spring loaded to a default position where one of the blocking elements is in a blocking position that blocks a food storage cartridge at the dispensing end of the chute and another blocking element is in a passing position.

5. The automated meal preparation system of claim 1, wherein one of the blocking element moves from a blocking position to a passing position, another blocking element moves from a passing position to a blocking position, a food storage cartridge at the dispensing end of the chute passes to the basket, and a next food storage cartridge in the chute is blocked when the actuation stem is actuated.

6. The automated meal preparation system of claim 1, wherein the basket is configured to be manipulated by a robotic manipulator to transport food storage cartridges from the food storage matrix to a downstream component of the automated meal preparation system.

7. The automated meal preparation system of claim 6, further
comprising: wherein the robotic manipulator is coupled to the basket; and
an actuator located at the basket, wherein the actuator actuates the actuation stem of the mechanical cartridge dispenser of a chute when the basket is located at the dispensing end of the chute such that a food storage cartridge passes from the chute into the basket.

8. The automated meal preparation system of claim 6, wherein the downstream component is a conveyer having at least a receiving end and one or more gates.

9. The automated meal preparation system of claim 6, further comprising:
a gripping mechanism that holds a food storage cartridge and moves the food storage cartridge from a receiving position to an unpacking position, wherein the robotic manipulator facilitates delivery of the food storage cartridge from the food storage matrix to the gripping mechanism.

10. The automated meal preparation system of claim 9, further comprising:
a catapult arm having a holding component that holds a container of the food storage cartridge at the unpacking position and rotates to empty food from the food storage cartridge container.

11. The automated meal preparation system of claim 10, wherein the catapult arm operates with the gripping mechanism to separate a food storage cartridge lid from the food storage cartridge container.

12. The automated meal preparation system of claim 10, further comprising:
a salad preparation module including a stand and a bowl that receives salad ingredients.

13. The automated meal preparation system of claim 10, further comprising:
a soup preparation module including a stand, a bowl, and a boiler having an outlet that dispenses soup from the boiler into the bowl.

14. The automated meal preparation system of claim 13, further comprising:
a hot bowl preparation module including a cooking receptacle that receives food from a food storage cartridge delivered through the automated meal preparation system, the cooking receptacle having an upper opening that receives the food, a bottom, one or more sidewalls, at least one protrusion extending inward from the one or more sidewalls, a heating element positioned behind the one or more sidewalls, a spinner, and a rotator, wherein the spinner spins the cooking receptacle and the at least one protrusion mixes the food while the heating element cooks the food, and wherein the rotator rotates the cooking receptacle to empty the food from the cooking receptacle when the food is finished cooking.

15. An automated meal preparation system, comprising:
a food storage matrix having a plurality of chutes arranged in rows and columns, the plurality of chutes being configured to hold a plurality of food storage cartridges;
a mechanical cartridge dispenser located at the dispensing end of one or more of the plurality of chutes, the mechanical cartridge dispenser having blocking elements and an actuation stem, wherein the blocking elements have one position that blocks the passage of food storage cartridges and another position that allows the passage of food storage cartridges;
a basket that receives one or more food storage cartridges when the basket is positioned at the dispensing end of one of the plurality of chutes;
a manipulator coupled to the basket, wherein the manipulator moves the basket to the dispensing end of one of the plurality of chutes to receive one or more food storage cartridges located at the dispensing end of the chute;
an actuator located at the basket, wherein the actuator actuates the actuation stem of the mechanical cartridge dispenser of a chute when the basket is located at the dispensing end of the chute such that one or more food storage cartridges pass from the chute into the basket;
one or more buffer queues extending from each of the one or more gates, each of the buffer queues having a receiving end at the gate that is elevated above a delivery end, wherein a food storage cartridge travels from the receiving end to the delivery end;
a catapult arm that rotates to empty food from the food storage cartridge;
a food preparation receptacle that receives the food from the food storage cartridge container when the catapult arm empties the food, the food preparation receptacle; and
at least one processor that controls the motions of at least the manipulator and catapult arm.

16. The automated meal preparation system of claim 15, wherein at least some of the plurality of chutes include a loading end elevated above a dispensing end.

17. The automated meal preparation system of claim 15, further including:
a gripping mechanism located at the delivery end of at least one of the one or more buffer queues, wherein the gripping mechanism holds a food storage cartridge that has traveled along a buffer queue and moves the food storage cartridge from a receiving position to the unpacking position.

18. The automated meal preparation system of claim 17, wherein the catapult arm includes a holding component that holds a container of a food storage cartridge at the unpacking position and operates with the gripping mechanism to separate a food storage cartridge lid from the food storage cartridge container, wherein the gripping mechanism moves the food storage cartridge lid away from the food storage cartridge container and the catapult arm rotates to empty food from the food storage cartridge container after separation.

19. The automated meal preparation system of claim 15, wherein each food storage cartridge includes a unique identifier that is machine readable by the automated meal preparation system.

20. The automated meal preparation system of claim 19, wherein the food storage matrix is equipped with a reader to manually read unique identifiers of incoming food storage cartridges.

21-46. (canceled)
